(19) United States
(12) Patent Application Publication
(10) Pub. No.: US 2024/0239467 A1
(43) Pub. Date: Jul. 18, 2024

(54) COMMUNICATION SYSTEM FOR OUTBOARD MOTOR, MARINE VESSEL, AND COMMUNICATION SYSTEM FOR PROPULSION DEVICE

(71) Applicant: YAMAHA HATSUDOKI KABUSHIKI KAISHA, Iwata-shi (JP)

(72) Inventor: Tatsuhiko NOGAMI, Shizuoka (JP)

(21) Appl. No.: 18/539,354

(22) Filed: Dec. 14, 2023

(30) Foreign Application Priority Data
Jan. 13, 2023 (JP) 2023-003874

(51) Int. Cl. B63H 21/21; B63B 79/40

(52) U.S. Cl. CPC B63H 21/21; B63B 79/40; B63H 2021/216

(57) ABSTRACT

A communication system for an outboard motor includes a main bus line including a first end and a second end each located in a hull, two signal lines to transmit data using a voltage difference between the two signal lines, and operable to communicate with the outboard motor, an in-hull maneuvering controller at the first end of the main bus line, a first terminating resistor in the in-hull maneuvering controller to electrically connect the two signal lines, and a second terminating resistor at the second end of the main bus line to electrically connect the two signal lines. The main bus line extends from the first terminating resistor to outside the hull, through the outboard motor, and then back into the hull to connect to the second terminating resistor.

### CROSS REFERENCE TO RELATED APPLICATIONS

This application claims the benefit of priority to Japanese Patent Application No. 2023-003874 filed on Jan. 13, 2023. The entire contents of this application are hereby incorporated herein by reference.

### BACKGROUND OF THE INVENTION

### 1. Field of the Invention

The present invention relates to communication systems for outboard motors, marine vessels, and communication systems for propulsion devices.

### 2. Description of the Related Art

A communication system for an outboard motor including a bus line that includes two signal lines to transmit data between an in-hull maneuvering controller in a hull and an outboard motor using a voltage difference between the two signal lines is known in general. Such a communication system is disclosed in Japanese Patent Laid-Open No. 2007-309294, for example.

Japanese Patent Laid-Open No. 2007-309294 discloses an outboard motor operation system for a marine vessel including a CAN cable that includes a high-level signal line and a low-level signal line. The outboard motor operation system further includes one outboard motor and a remote control ECU in a hull, and transmits data between the outboard motor and the remote control ECU via the CAN cable. A first end of the CAN cable is located in the hull, and a terminating resistor is provided at the first end to reduce noise as a reflected wave. A second end of the CAN cable is located inside the outboard motor, and a terminating resistor is provided at the second end to reduce noise as a reflected wave.

Although not clearly described in Japanese Patent Laid-Open No. 2007-309294, in the field of outboard motor operation systems described in Japanese Patent Laid-Open No. 2007-309294, a system to operate a plurality of outboard motors may be constructed using outboard motors including terminating resistors as described above. In such a case, it is necessary to connect the plurality of outboard motors by a CAN cable and then carry out wiring such that only one of the terminating resistors in the plurality of outboard motors is functional. In such a case, there is an unused (wasted) terminating resistor among the terminating resistors located in the outboard motors, and thus an improvement is desired.

### SUMMARY OF THE INVENTION

Preferred embodiments of the present invention provide communication systems for outboard motors, marine vessels, and communication systems for propulsion devices that each prevent unused terminating resistors.

A communication system for an outboard motor according to a preferred embodiment of the present invention includes a main bus line including a first line and a second line each located in a hull, two signal lines to transmit data using a voltage difference between the two signal lines, and operable to communicate with the outboard motor, an in-hull maneuvering controller at the first end of the main bus line, a first terminating resistor in the in-hull maneuvering controller to electrically connect the two signal lines, and a second terminating resistor at the second end of the main bus line to electrically connect the two signal lines. The main bus line extends from the first terminating resistor to outside the hull, through the outboard motor, and then back into the hull to connect to the second terminating resistor.

A communication system for an outboard motor according to a preferred embodiment of the present invention includes the first terminating resistor in the in-hull maneuvering controller to electrically connect the two signal lines, and the second terminating resistor at the second end of the main bus line to electrically connect the two signal lines, and the main bus line extends from the first terminating resistor to outside the hull, through the outboard motor, and then back into the hull to connect to the second terminating resistor. Accordingly, the main bus line makes a U-turn, and thus the main bus line returns into the hull after passing through the outboard motor such that both ends of the main bus line are located in the hull. Therefore, the two terminating resistors, the first terminating resistor and the second terminating resistor, are located in the hull such that the terminating resistors are not located inside the outboard motor. Thus, the number of terminating resistors does not vary depending on the number of outboard motors unlike the conventional case, and the number of terminating resistors in the communication system is reduced or minimized. Consequently, an unused terminating resistor is prevented.

A communication system for an outboard motor according to a preferred embodiment of the present invention preferably further includes a motor controller in the outboard motor and configured or programmed to control operation of the outboard motor, and a stub line connected to the motor controller. The main bus line preferably includes a U-turn line outside the hull connected to the motor controller via the stub line. Accordingly, the stub line and the U-turn line facilitate communication between the in-hull maneuvering controller and the motor controller, and the main bus line easily returns into the hull from inside the outboard motor.

In such a case, the main bus line preferably includes a first end line connected to the first terminating resistor in the hull, and a second end line connected to the second terminating resistor in the hull, the first end line is preferably connected to the second end line by the U-turn line, and the U-turn line is preferably attachable to and detachable from the first end line and the second end line. Accordingly, the U-turn line is attachable to and detachable from the first end line and the second end line, and thus the lines are easily connected to each other.

In a communication system for an outboard motor in which the first end line is connected to the second end line by the U-turn line, the motor controller preferably includes a first motor controller and a second motor controller, the outboard motor preferably includes a first outboard motor including the first motor controller, and a second outboard motor including the second motor controller. The stub line preferably includes a first stub line to connect the main bus line to the first motor controller, and a second stub line to connect the main bus line to the second motor controller. The U-turn line preferably includes a first U-turn line connected to the first end line and the first motor controller via the first stub line, and a second U-turn line connected to the second end line and the second motor controller via the second stub line. The main bus line preferably further includes a connector line to connect the first U-turn line to the second U-turn line. Accordingly, the first stub line, the second stub line, the first U-turn line, and the second U-turn line facilitate communication between the in-hull maneuvering controller, the first motor controller, and the second motor controller, and the main bus line easily returns into the hull from inside the outboard motor.

In a communication system for an outboard motor in which the stub line includes the first stub line and the second stub line, and the U-turn line includes the first U-turn line and the second U-turn line, the first U-turn line and the first stub line are preferably located inside the first outboard motor, and the second U-turn line and the second stub line are preferably located inside the second outboard motor. Accordingly, the first U-turn line and the first stub line are housed in the first outboard motor, and the second U-turn line and the second stub line are housed in the second outboard motor, and thus complex wiring outside the outboard motor is reduced or prevented.

In a communication system for an outboard motor in which the stub line includes the first stub line and the second stub line, and the U-turn line includes the first U-turn line and the second U-turn line, the first U-turn line and the second U-turn line, each of which is a portion of the main bus line, preferably have a same structure as each other. Accordingly, the first U-turn line in the first outboard motor and the second U-turn line in the second outboard motor have the same structure as each other, and thus even when the positions of the first outboard motor and the second outboard motor are swapped or the positions of the first U-turn line and the second U-turn line are swapped, the in-hull maneuvering controller, the first motor controller, and the second motor controller are communicably connected to each other.

A communication system for an outboard motor in which the first end line is connected to the second end line by the U-turn line preferably further includes a first connector to detachably connect the U-turn line to the first end line and the second end line. Accordingly, the U-turn line is easily connected to the first end line by the first connector.

In such a case, the first connector is preferably integral and unitary with the outboard motor. Accordingly, the number of separate components in the system is reduced such that the system structure is simplified.

In a communication system for an outboard motor including the first connector, the first end line preferably includes a first line connected to the first terminating resistor, and a second line connected to the first connector, and the communication system preferably further includes a second connector to detachably connect the first line to the second line in the hull. Accordingly, the first end line is shortened by being separated into two portions, the first line and the second line, and thus the first end line is easily routed without tangling. Furthermore, the first line is easily connected to the second line by the second connector.

In a communication system for an outboard motor according to a preferred embodiment of the present invention, the two signal lines of the main bus line preferably include a high bus line that is at a higher voltage during data transmission, and a low bus line that is at a lower voltage during data transmission, and the main bus line is preferably operable to use a CAN communication standard and to transmit data based on a voltage difference between the high bus line and the low bus line. Accordingly, in the communication system operable on the CAN communication standard, an unused termination resistor is prevented.

In such a case, the high bus line and the low bus line of the main bus line are preferably twisted together and to connect the first terminating resistor to the second terminating resistor. Accordingly, the high bus line and the low bus line are a so-called twisted cable, and thus noise during data transmission is reduced.

A marine vessel according to a preferred embodiment of the present invention includes a hull, and a communication system for an outboard motor attached to the hull, the communication system being mounted on the hull. The communication system further includes a main bus line including two signal lines to transmit data using a voltage difference between the two signal lines, and operable to communicate with the outboard motor, an in-hull maneuvering controller at a first end of the main bus line in the hull, a first terminating resistor in the in-hull maneuvering controller to electrically connect the two signal lines, and a second terminating resistor at a second end of the main bus line to electrically connect the two signal lines. The main bus line extends from the first terminating resistor to outside the hull, through the outboard motor, and then back into the hull to connect to the second first terminating resistor.

A marine vessel according to a preferred embodiment of the present invention includes the first terminating resistor in the in-hull maneuvering controller to electrically connect the two signal lines, and the second terminating resistor at the second end of the main bus line to electrically connect the two signal lines, and the main bus line extends from the first terminating resistor to outside the hull, through the outboard motor, and then back into the hull to connect to the second terminating resistor. Accordingly, the main bus line makes a U-turn, and thus the main bus line returns into the hull after passing through the outboard motor such that both ends of the main bus line are located in the hull. Therefore, the two terminating resistors, the first terminating resistor and the second terminating resistor, are located in the hull such that the terminating resistors are not located inside the outboard motor. Thus, the number of terminating resistors does not vary depending on the number of outboard motors unlike the conventional case, and the number of terminating resistors in the communication system is reduced or minimized. Consequently, an unused terminating resistor is prevented.

In a marine vessel according to a preferred embodiment of the present invention, the outboard motor preferably includes a motor controller inside the outboard motor and configured or programmed to control operation of the outboard motor. The communication system preferably further includes a stub line connected to the motor controller. The main bus line preferably includes a U-turn line outside the hull connected to the motor controller via the stub line. Accordingly, the stub line and the U-turn line facilitate communication between the in-hull maneuvering controller and the motor controller, and the main bus line easily returns into the hull from inside the outboard motor.

In such a case, the main bus line preferably includes a first end line connected to the first terminating resistor in the hull, and a second end line connected to the second terminating resistor in the hull, the first end line is preferably connected to the second end line by the U-turn line, and the U-turn line is preferably attachable to and detachable from the first end line and the second end line. Accordingly, the U-turn line is attachable to and detachable from the first end line and the second end line, and thus the lines are easily connected to each other.

In a marine vessel in which the first end line is connected to the second end line by the U-turn line, the motor controller preferably includes a first motor controller and a second motor controller, the outboard motor preferably includes a first outboard motor including the first motor controller, and a second outboard motor including the second motor controller. The stub line preferably includes a first stub line to connect the main bus line to the first motor controller, and a second stub line to connect the main bus line to the second motor controller. The U-turn line preferably includes a first U-turn line connected to the first end line and the first motor controller via the first stub line, and a second U-turn line connected to the second end line and the second motor controller via the second stub line. The main bus line preferably further includes a connector line to connect the first U-turn line to the second U-turn line. Accordingly, the first stub line, the second stub line, the first U-turn line, and the second U-turn line facilitate communication between the in-hull maneuvering controller, the first motor controller, and the second motor controller, and the main bus line easily returns into the hull from inside the outboard motor.

In a marine vessel in which the stub line includes the first stub line and the second stub line, and the U-turn line includes the first U-turn line and the second U-turn line, the first U-turn line and the first stub line are preferably located inside the first outboard motor, and the second U-turn line and the second stub line are preferably located inside the second outboard motor. Accordingly, the first U-turn line and the first stub line are housed in the first outboard motor, and the second U-turn line and the second stub line are housed in the second outboard motor, and thus complex wiring outside the outboard motor is reduced or prevented.

In a marine vessel in which the stub line includes the first stub line and the second stub line, and the U-turn line includes the first U-turn line and the second U-turn line, the first U-turn line and the second U-turn line, each of which is a portion of the main bus line, preferably have the same structure as each other. Accordingly, the first U-turn line in the first outboard motor and the second U-turn line in the second outboard motor have the same structure as each other, and thus even when the positions of the first outboard motor and the second outboard motor are swapped or the positions of the first U-turn line and the second U-turn line are swapped, the in-hull maneuvering controller, the first motor controller, and the second motor controller are communicably connected to each other.

In a marine vessel in which the first end line is connected to the second end line by the U-turn line, the communication system preferably further includes a connector to detachably connect the U-turn line to the first end line and the second end line. Accordingly, the U-turn line is easily connected to the first end line by the connector.

In such a case, the connector is preferably integral and unitary with the outboard motor. Accordingly, the number of separate components in the system is reduced such that the system structure is simplified.

A communication system for a propulsion device according to a preferred embodiment of the present invention includes a main bus line including two signal lines to transmit data using a voltage difference between the two signal lines, and operable to communicate with a marine propulsion device, an in-hull maneuvering controller at a first end of the main bus line, a first terminating resistor in the in-hull maneuvering controller to electrically connect the two signal lines, and a second terminating resistor at a second end of the main bus line to electrically connect the two signal lines. The main bus line extends from the first terminating resistor to outside the hull, through the marine propulsion device, and then back into the hull to connect to the second terminating resistor.

A communication system for a propulsion device according to a preferred embodiment of the present invention includes the first terminating resistor in the in-hull maneuvering controller to electrically connect the two signal lines, and the second terminating resistor at the second end of the main bus line to electrically connect the two signal lines, and the main bus line extends from the first terminating resistor to outside the hull, through the marine propulsion device, and back into the hull to connect to the second terminating resistor. Accordingly, the main bus line makes a U-turn, and thus the main bus line returns into the hull after passing through the marine propulsion device such that both ends of the main bus line are located in the hull. Therefore, the two terminating resistors, the first terminating resistor and the second terminating resistor, are located in the hull such that the terminating resistors are not located inside the marine propulsion device. Thus, the number of terminating resistors does not vary depending on the number of marine propulsion devices unlike the conventional case, and the number of terminating resistors in the communication system is reduced or minimized. Consequently, an unused terminating resistor is prevented.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a diagram schematically showing a marine vessel including a communication system for an outboard motor according to a preferred embodiment of the present invention.

FIG. 2 is a side view showing an outboard motor in a communication system according to a preferred embodiment of the present invention.

FIG. 3 is a diagram schematically showing a system structure of a communication system for an outboard motor according to a preferred embodiment of the present invention.

FIG. 4 is a diagram schematically showing a state in which a communication system for an outboard motor according to a preferred embodiment of the present invention has been changed from a system including two outboard motors to a system including one outboard motor.

### DETAILED DESCRIPTION OF THE PREFERRED EMBODIMENTS

Preferred embodiments of the present invention are hereinafter described with reference to the drawings.

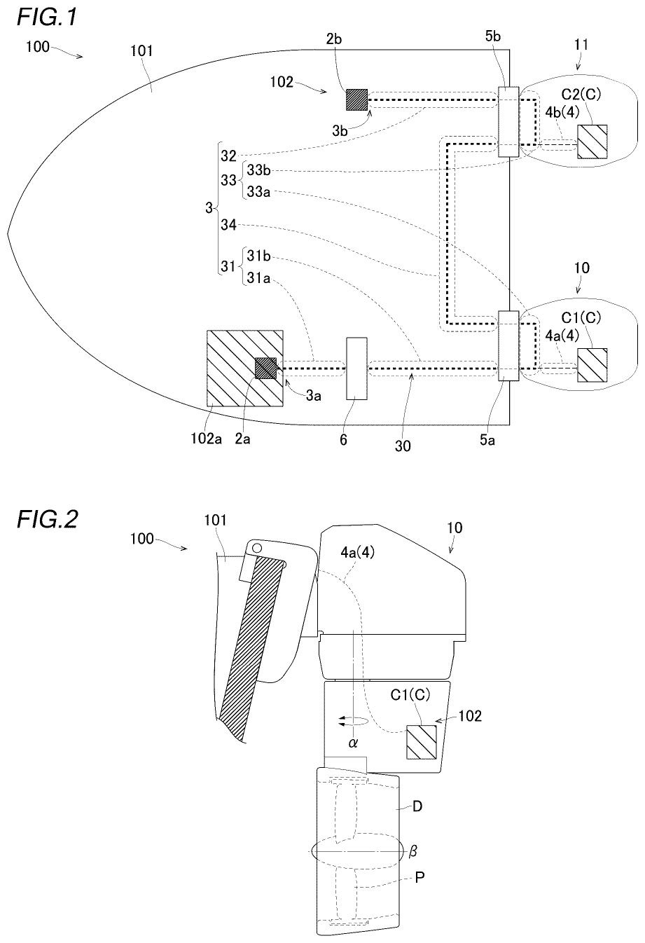

The structure of a marine vessel 100 including a communication system 102 for an outboard motor according to preferred embodiments of the present invention is now described with reference to FIGS. 1 to 4. The communication system 102 is an example of a “communication system for a propulsion device”.

As shown in FIGS. 1 and 2, the marine vessel 100 includes a hull 101 and the communication system 102 mounted on the hull 101. The communication system 102 includes an outboard motor 1 on the hull 101. The outboard motor 1 is an example of a “marine propulsion device”.

The outboard motor 1 is attached to a transom of the hull 101. The outboard motor 1 includes a first outboard motor 10 and a second outboard motor 11. The first outboard motor 10 and the second outboard motor 11 are aligned side by side along a right-left direction of the hull 101. The first outboard motor 10 and the second outboard motor 11 preferably have the same structure as each other. Therefore, the first outboard motor 10 is described below.

The first outboard motor 10 shown in FIG. 2 is an electric propulsion device in which a propeller P is driven by an electric motor. The first outboard motor 10 is a duct-driven propulsion device in which the electric motor is integral and unitary with a duct D and the propeller P. The first outboard motor 10 rotates the duct D and the propeller P in the right-left direction by a steering mechanism (not shown) about a central axis α. The propeller P rotates about a central axis β.

Each of the first outboard motor 10 and the second outboard motor 11 includes a motor controller C configured or programmed to control operation of the electric motor, for example, that is a drive source for the propeller P.

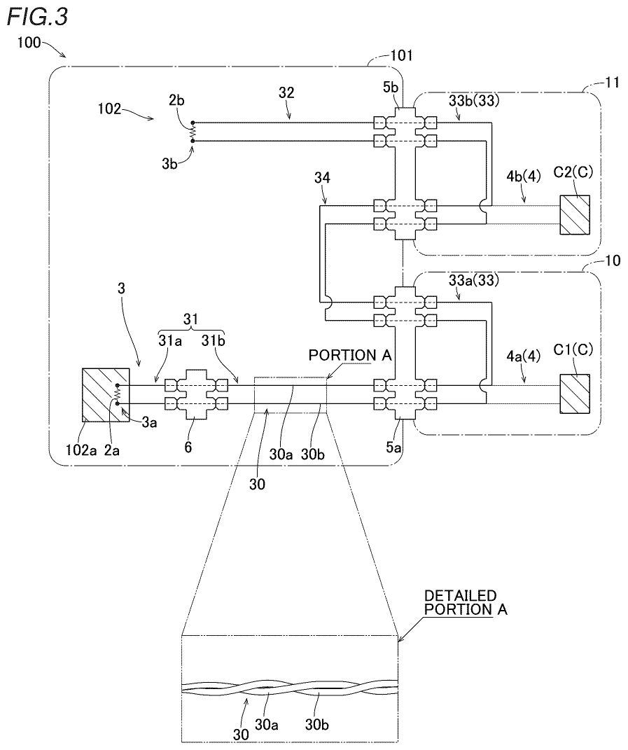

As shown in FIGS. 1 and 3, the communication system 102 includes an in-hull maneuvering controller 102a, a first terminating resistor 2a, a second terminating resistor 2b, a main bus line 3, a stub line 4 connected to the in-hull maneuvering controller 102a, first connectors 5a and 5b, and a second connector 6.

The main bus line 3 includes two signal lines 30 to transmit data using a voltage difference between the two signal lines 30. The main bus line 3 communicates with the outboard motor 1 (the first outboard motor 10 and the second outboard motor 11).

Specifically, the two signal lines 30 of the main bus line 3 include a high bus line 30a that is at a higher voltage during data transmission, and a low bus line 30b that is at a lower voltage, i.e., at a voltage lower than the higher voltage, during data transmission. The main bus line 3 uses a CAN (controller area network) communication standard to transmit data based on a voltage difference between the high bus line 30a and the low bus line 30b.

That is, the communication system 102 uses a so-called two-wire differential voltage system. In the two-wire differential voltage system, the same noise is generated on the high bus line 30a and the low bus line 30b at the same time, and thus the noise does not affect the voltage difference (transmitted data) between the high bus line 30a and the low bus line 30b. Therefore, the two-wire differential voltage system is a communication system with high noise resistance.

The high bus line 30a and the low bus line 30b of the main bus line 3 have the same or substantially the same lengths. The high bus line 30a and the low bus line 30b of the main bus line 3 are in parallel to each other. The high bus line 30a and the low bus line 30b of the main bus line 3 are twisted together and connect the first terminating resistor 2a to the second terminating resistor 2b.

The in-hull maneuvering controller 102a is located at a first end 3a of the main bus line 3 in the hull 101. The in-hull maneuvering controller 102a controls driving of the outboard motor 1 (the first outboard motor 10 and the second outboard motor 11). The in-hull maneuvering controller 102a includes a CPU and a memory.

As an example, the in-hull maneuvering controller 102a includes a so-called boat control unit to adjust operation, e.g., driving, of the first outboard motor 10 and the second outboard motor 11 to perform automatic marine vessel maneuvering. In addition, the in-hull maneuvering controller may include a master remote control ECU including one remote control ECU for each outboard motor, for example.

The motor controller C includes a first motor controller C1 and a second motor controller C2. The first outboard motor 10 includes the first motor controller C1. The second outboard motor 11 includes the second motor controller C2. The first motor controller C1 and the second motor controller C2 preferably have the same structure as each other. Each of the first motor controller C1 and the second motor controller C2 includes a CPU and a memory.

The first terminating resistor 2a is provided in the in-hull maneuvering controller 102a located at the first end 3a of the main bus line 3. The first terminating resistor 2a electrically connects the two signal lines 30 (the high bus line 30a and the low bus line 30b). The first terminating resistor 2a reduces or prevents signal reflection generated at terminations of the high bus line 30a and the low bus line 30b (the first end 3a of the main bus line 3) during data transmission. In short, the first terminating resistor 2a reduces or prevents noise by consuming reflected energy that causes noise.

The second terminating resistor 2b is provided at a second end 3b of the main bus line 3. The second terminating resistor 2b electrically connects the two signal lines 30 (the high bus line 30a and the low bus line 30b). The second terminating resistor 2b reduces or prevents signal reflection generated at terminations of the high bus line 30a and the low bus line 30b (the second end 3b of the main bus line 3) during data transmission. In short, the second terminating resistor 2b reduces or prevents noise by consuming reflected energy that causes noise.

The communication system 102 includes only two terminating resistors, the first terminating resistor 2a and the second terminating resistor 2b.

The main bus line 3 extends from the first terminating resistor 2a to outside the hull 101, through the outboard motor 1, and then back into the hull 101 to connect to the second terminating resistor 2b. Specifically, the main bus line 3 includes a U-turn line 33 that doubles back outside the hull 101 to connect to the motor controller C via the stub line 4.

The main bus line 3 includes a first end line 31 connected to the first terminating resistor 2a in the hull 101, and a second end line 32 connected to the second terminating resistor 2b in the hull 101.

The U-turn line 33 includes a first U-turn line 33a and a second U-turn line 33b. In the main bus line 3, the first end line 31 is connected to the second end line 32 by the U-turn line 33 outside the hull 101. The U-turn line 33 that makes a U-turn outside of the hull 101 is located inside of the first outboard motor 10 and inside of the second outboard motor 11.

The stub line 4 includes a first stub line 4a and a second stub line 4b. The first stub line 4a connects the main bus line 3 to the first motor controller C1. The second stub line 4b connects the main bus line 3 to the second motor controller C2.

The first U-turn line 33a is connected to the first end line 31 and the first motor controller C1 via the first stub line 4a. The second U-turn line 33b is connected to the second end line 32 and the second motor controller C2 via the second stub line 4b. The first U-turn line 33a and the second U-turn line 33b, each of which is a portion of the main bus line 3, have the same structure as each other.

The main bus line 3 includes a connector line 34. The connector line 34 connects the first U-turn line 33a to the second U-turn line 33b outside the outboard motor 1 (between the first outboard motor 10 and the second outboard motor 11).

Each of the first end line 31, the second end line 32, the first U-turn line 33a, the second U-turn line 33b, and the connector line 34 includes the high bus line 30a and the low bus line 30b in parallel to each other.

The U-turn line 33 of the main bus line 3 is attachable to and detachable from the first end line 31 and the second end line 32. The first connectors 5a and 5b are used to attach and detach the U-turn line 33 to and from the first end line 31 and the second end line 32.

The first U-turn line 33a and the first stub line 4a are located inside the first outboard motor 10. The second U-turn line 33b and the second stub line 4b are located inside the second outboard motor 11.

The first connector 5a is integral and unitary with the first outboard motor 10. The first connector 5b is integral and unitary with the second outboard motor 11. The first connectors 5a and 5b detachably connect the U-turn line 33 to the first end line 31 and the second end line 32.

Specifically, the first connector 5a connects the first U-turn line 33a to the first end line 31. Thus, the first U-turn line 33a and the first end line 31 are electrically connected to each other via the first connector 5a. The first connector 5b connects the second U-turn line 33b to the second end line 32. Thus, the second U-turn line 33b and the second end line 32 are electrically connected to each other via the first connector 5b.

The first connector 5a connects the first U-turn line 33a to a first end of the connector line 34. Thus, the first U-turn line 33a and the connector line 34 are electrically connected to each other via the first connector 5a. The first connector 5b connects the second U-turn line 33b to a second end of the connector line 34. Thus, the second U-turn line 33b and the connector line 34 are electrically connected to each other via the first connector 5b.

Therefore, the first end line 31 and the second end line 32 are electrically connected to each other via the first connector 5a, the first U-turn line 33a, the connector line 34, the first connector 5b, and the second U-turn line 33b.

The first end line 31 includes a first line 31a connected to the first terminating resistor 2a and a second line 31b connected to the first connectors 5a and 5b. The second connector 6 detachably connects the first line 31a to the second line 31b in the hull 101.

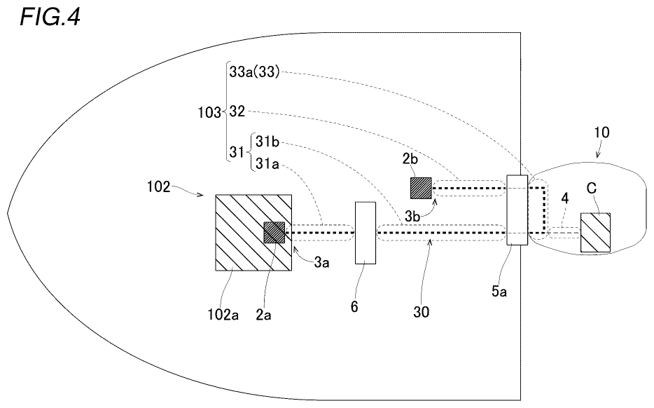

As shown in FIG. 4, the communication system 102 is easily changed from a system including two outboard motors to a system including one outboard motor by rearranging the system components.

Specifically, the second end line 32 is detached from the first connector 5b, and the connector line 34 is detached from the first connector 5a. Then, the second end line 32 is connected to a position of the first connector 5a to which the connector line 34 used to be connected. Consequently, the communication system 102 is changed from a system including two outboard motors to a system including one outboard motor. In such a case, a main bus line 103 includes the first end line 31, the first U-turn line 33a, and the second end line 32.

Furthermore, the communication system 102 is easily changed from a system including two outboard motors to a system including three or more outboard motors by rearranging the system components.

According to the various preferred embodiments of the present invention described above, the following advantageous effects are achieved.

According to a preferred embodiment of the present invention, the communication system 102 includes the first terminating resistor 2a in the in-hull maneuvering controller 102a to electrically connect the two signal lines 30, and the second terminating resistor 2b at the second end 3b of the main bus line 3 to electrically connect the two signal lines 30, and the main bus line 3 extends from the first terminating 2a to outside hull 101, through the outboard motor 1, and then back into the hull 101 to connect to the second terminating resistor 2b. Accordingly, the main bus line 3 makes a U-turn, and thus the main bus line 3 returns into the hull 101 after passing through the outboard motor 1 such that both ends of the main bus line 3 are located in the hull 101. Therefore, the two terminating resistors, the first terminating resistor 2a and the second terminating resistor 2b, are located in the hull 101 such that the terminating resistors are not located inside the outboard motor 1. Thus, the number of terminating resistors does not vary depending on the number of outboard motors 1 unlike the conventional case, and the number of terminating resistors in the communication system is minimized. Consequently, an unused terminating resistor is prevented.

According to a preferred embodiment of the present invention, the communication system 102 further includes the motor controller C configured or programmed to control operation of the outboard motor 1, and the stub line 4 connected to the motor controller C, and the main bus line 3 includes the U-turn line 33 that makes a U-turn outside the hull 101 and is connected to the motor controller C via the stub line 4. Accordingly, the stub line 4 and the U-turn line 33 facilitate communication between the in-hull maneuvering controller 102a and the motor controller C, and the main bus line 3 easily returns into the hull 101 from inside the outboard motor 1.

According to a preferred embodiment of the present invention, the main bus line 3 includes the first end line 31 connected to the first terminating resistor 2a in the hull 101, and the second end line 32 connected to the second terminating resistor 2b in the hull 101, and the first end line 31 is connected to the second end line 32 by the U-turn line 33 that makes a U-turn outside the hull 101. Furthermore, the U-turn line 33 is attachable to and detachable from the first end line 31 and the second end line 32. Accordingly, the U-turn line 33 is attachable to and detachable from the first end line 31 and the second end line 32, and thus the lines are easily connected to each other.

According to a preferred embodiment of the present invention, the outboard motor 1 includes the first outboard motor 10 including the first motor controller C1, and the second outboard motor 11 including the second motor controller C2. The stub line 4 includes the first stub line 4a to connect the main bus line 3 to the first motor controller C1, and the second stub line 4b to connect the main bus line 3 to the second motor controller C2. The U-turn line 33 includes the first U-turn line 33a connected to the first end line 31 and to the first motor controller C1 via the first stub line 4a, and the second U-turn line 33b connected to the second end line 32 and to the second motor controller C2 via the second stub line 4b. The main bus line 3 further includes the connector line 34 to connect the first U-turn line 33a to the second U-turn line 33b. Accordingly, the first stub line 4a, the second stub line 4b, the first U-turn line 33a, and the second U-turn line 33b facilitate communication between the in-hull maneuvering controller 102a, the first motor controller C1, and the second motor controller C2, and the main bus line 3 easily returns into the hull 101 from inside the outboard motor 1.

According to a preferred embodiment of the present invention, the first U-turn line 33a and the first stub line 4a are located inside the first outboard motor 10, and the second U-turn line 33b and the second stub line 4b are located inside the second outboard motor 11. Accordingly, the first U-turn line 33a and the first stub line 4a are housed in the first outboard motor 10, and the second U-turn line 33b and the second stub line 4b are housed in the second outboard motor 11, and thus complex wiring outside the outboard motor 1 is reduced or prevented.

According to a preferred embodiment of the present invention, the first U-turn line 33a and the second U-turn line 33b, each of which is a portion of the main bus line 3, have the same structure as each other. Accordingly, the first U-turn line 33a in the first outboard motor 10 and the second U-turn line 33b in the second outboard motor 11 have the same structure as each other, and thus even when the positions of the first outboard motor 10 and the second outboard motor 11 are swapped or the positions of the first U-turn line 33a and the second U-turn line 33b are swapped, the in-hull maneuvering controller 102a, the first motor controller C1, and the second motor controller C2 are communicably connected to each other.

According to a preferred embodiment of the present invention, the communication system 102 further includes the first connectors 5a and 5b to detachably connect the U-turn line 33 to the first end line 31 and the second end line 32. Accordingly, the U-turn line 33 is easily connected to the first end line 31 by the first connectors 5a and 5b.

According to a preferred embodiment of the present invention, the first connectors 5a and 5b are integral and unitary with the outboard motor 1. Accordingly, the number of separate components in the system is reduced such that the system structure is simplified.

According to a preferred embodiment of the present invention, the first end line 31 includes the first line 31a connected to the first terminating resistor 2a, and the second line 31b connected to the first connectors 5a and 5b, and the communication system 102 further includes the second connector 6 to detachably connect the first line 31a to the second line 31b in the hull 101. Accordingly, the first end line 31 is shortened by being separated into two portions, the first line 31a and the second line 31b, and thus the first end line 31 is easily routed without tangling. Furthermore, the first line 31a is easily connected to the second line 31b by the second connector 6.

According to a preferred embodiment of the present invention, the two signal lines 30 of the main bus line 3 include the high bus line 30a that is at a higher voltage during data transmission, and the low bus line 30b that is at a lower voltage during data transmission, and the main bus line 3 is operable on the CAN communication standard to transmit data based on the voltage difference between the high bus line 30a and the low bus line 30b. Accordingly, in the communication system 102 using the CAN communication standard, an unused termination resistor is prevented.

According to a preferred embodiment of the present invention, the high bus line 30a and the low bus line 30b of the main bus line 3 are twisted together to connect the first terminating resistor 2a to the second terminating resistor 2b. Accordingly, the high bus line 30a and the low bus line 30b are a so-called twisted cable, and thus noise during data transmission is reduced.

The preferred embodiments of the present invention described above are illustrative in all points and not restrictive. The extent of the present invention is not defined by the above description of the preferred embodiments but by the scope of the claims, and all modifications within the meaning and range equivalent to the scope of the claims are further included.

For example, while the marine vessel preferably includes the outboard motor in preferred embodiments described above, the present invention is not restricted to this. In a preferred embodiment of the present invention, the marine vessel may alternatively include an inboard-outboard motor, for example, instead of the outboard motor.

While the marine vessel preferably includes one or two outboard motors in preferred embodiments described above, the present invention is not restricted to this. In a preferred embodiment of the present invention, the marine vessel may alternatively include three or more outboard motors.

While the outboard motor is preferably electrically driven with an electric motor as a drive source in preferred embodiments described above, the present invention is not restricted to this. In a preferred embodiment of the present invention, the outboard motor may alternatively be an engine-driven with an engine as a drive source.

While the marine vessel preferably includes the first connectors in preferred embodiments described above, the present invention is not restricted to this. In a preferred embodiment of the present invention, the marine vessel may not include the first connectors.

While the marine vessel preferably includes the second connector in preferred embodiments described above, the present invention is not restricted to this. In a preferred embodiment of the present invention, the marine vessel may not include the second connector.

While the main bus line preferably uses the CAN communication standard to transmit data based on the voltage difference between the high bus line and the low bus line in preferred embodiments described above, the present invention is not restricted to this. In a preferred embodiment of the present invention, the main bus line may alternatively use a two-wire differential voltage system standard different from the CAN communication standard.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A communication system for an outboard motor, the communication system comprising:
a main bus line including a first end and a second end each located in a hull, two signal lines to transmit data using a voltage difference between the two signal lines, and operable to communicate with the outboard motor;
an in-hull maneuvering controller at the first end of the main bus line;
a first terminating resistor in the in-hull maneuvering controller to electrically connect the two signal lines; and
a second terminating resistor at the second end of the main bus line to electrically connect the two signal lines; wherein
the main bus line extends from the first terminating resistor to outside the hull, through the outboard motor, and then back into the hull to connect to the second terminating resistor in the hull.

2. The communication system according to claim 1, further comprising:
a motor controller in the outboard motor and configured or programmed to control operation of the outboard motor; and
a stub line connected to the motor controller; wherein
the main bus line includes a U-turn line outside the hull connected to the motor controller via the stub line.

3. The communication system according to claim 2, wherein
the main bus line includes a first end line connected to the first terminating resistor, and a second end line connected to the second terminating resistor;
the first end line is connected to the second end line by the U-turn line; and
the U-turn line is attachable to and detachable from the first end line and the second end line.

4. The communication system according to claim 3, wherein
the motor controller includes a first motor controller and a second motor controller;
the outboard motor includes a first outboard motor including the first motor controller, and a second outboard motor including the second motor controller;
the stub line includes a first stub line to connect the main bus line to the first motor controller, and a second stub line to connect the main bus line to the second motor controller;
the U-turn line includes a first U-turn line connected to the first end line and to the first motor controller via the first stub line, and a second U-turn line connected to the second end line and to the second motor controller via the second stub line; and
the main bus line further includes a connector line to connect the first U-turn line to the second U-turn line.

5. The communication system according to claim 4, wherein
the first U-turn line and the first stub line are located inside the first outboard motor; and
the second U-turn line and the second stub line are located inside the second outboard motor.

6. The communication system according to claim 4, wherein the first U-turn line and the second U-turn line have a same structure as each other.

7. The communication system according to claim 3, further comprising:
a first connector to detachably connect the U-turn line to the first end line and the second end line.

8. The communication system according to claim 7, wherein the first connector is integral and unitary with the outboard motor.

9. The communication system according to claim 7, wherein
the first end line includes a first line connected to the first terminating resistor, and a second line connected to the first connector; and
the communication system further comprises a second connector to detachably connect the first line to the second line in the hull.

10. The communication system according to claim 1, wherein
the two signal lines of the main bus line include a high bus line that is at a higher voltage during data transmission, and a low bus line that is at a lower voltage than the higher voltage during data transmission; and
the main bus line is operable to use a CAN communication standard and to transmit data based on a voltage difference between the high bus line and the low bus line.

11. The communication system according to claim 10, wherein the high bus line and the low bus line of the main bus line are twisted together and connect the first terminating resistor to the second terminating resistor.

12. A marine vessel comprising:
a hull; and
a communication system for an outboard motor attached to the hull, the communication system being mounted on the hull; wherein
the communication system further includes:
a main bus line including two signal lines to transmit data using a voltage difference between the two signal lines, and operable to communicate with the outboard motor;
an in-hull maneuvering controller at a first end of the main bus line in the hull;
a first terminating resistor in the in-hull maneuvering controller to electrically connect the two signal lines; and
a second terminating resistor at a second end of the main bus line to electrically connect the two signal lines; and
the main bus line extends from the first terminating resistor to outside the hull, through the outboard motor, and then back into the hull to connect to the second terminating resistor in the hull.

13. The marine vessel according to claim 12, wherein
the outboard motor includes a motor controller configured or programmed to control operation of the outboard motor;
the communication system further includes a stub line connected to the motor controller; and
the main bus line includes a U-turn line outside the hull connected to the motor controller via the stub line.

14. The marine vessel according to claim 13, wherein
the main bus line includes a first end line connected to the first terminating resistor in the hull, and a second end line connected to the second terminating resistor in the hull;
the first end line is connected to the second end line by the U-turn line; and
the U-turn line is attachable to and detachable from the first end line and the second end line.

15. The marine vessel according to claim 14, wherein
the motor controller includes a first motor controller and a second motor controller;
the outboard motor includes a first outboard motor including the first motor controller, and a second outboard motor including the second motor controller;
the stub line includes a first stub line to connect the main bus line to the first motor controller, and a second stub line to connect the main bus line to the second motor controller;
the U-turn line includes a first U-turn line connected to the first motor controller via the first stub line and connected to the first end line, and a second U-turn line connected to the second motor controller via the second stub line and connected to the second end line; and
the main bus line further includes a connector line to connect the first U-turn line to the second U-turn line.

16. The marine vessel according to claim 15, wherein
the first U-turn line and the first stub line are located inside the first outboard motor; and
the second U-turn line and the second stub line are located inside the second outboard motor.

17. The marine vessel according to claim 15, wherein the first U-turn line and the second U-turn line, each of which is a portion of the main bus line, have a same structure as each other.

18. The marine vessel according to claim 14, wherein the communication system further includes a connector to detachably connect the U-turn line to the first end line and the second end line.

19. The marine vessel according to claim 18, wherein the connector is integral and unitary with the outboard motor.

20. A communication system for a propulsion device, the communication system comprising:
a main bus line including two signal lines to transmit data using a voltage difference between the two signal lines, and operable to communicate with the propulsion device;
an in-hull maneuvering controller at a first end of the main bus line;
a first terminating resistor in the in-hull maneuvering controller to electrically connect the two signal lines; and
a second terminating resistor at a second end of the main bus line to electrically connect the two signal lines; wherein
the main bus line extends from the first terminating resistor to outside the hull, through the propulsion device, and then back into the hull to connect to the second terminating resistor in the hull.
